(19) United States
(12) Patent Application Publication
(10) Pub. No.: US 2006/0152820 A1
(43) Pub. Date: Jul. 13, 2006

(54) Lens and light-emitting device including the lens

(75) Inventors: Chin-Chung Lien, Longtan Shiang (TW); Shi-Hwa Huang, Longtan Shiang (TW)

Correspondence Address: ZAGORIN O'BRIEN GRAHAM LLP, 7600B N. CAPITAL OF TEXAS HWY., SUITE 350, AUSTIN, TX, 78731, US

(73) Assignee: Shi-Hwa Huang

(21) Appl. No.: 11/175,503

(22) Filed: Jul. 6, 2005

(30) Foreign Application Priority Data
Jan. 10, 2005 (TW) 094100624

(51) Int. Cl. G02B 17/00

(52) U.S. Cl. 359/726

(57) ABSTRACT

A light-emitting device includes a light-emitting component and a lens. The lens includes a bottom surface, a first reflecting surface, a second reflecting surface, and a refracting surface such that light entering the lens through the bottom surface and directly incident on the first reflecting surface is reflected from the first reflecting surface to the second reflecting surface, is subsequently reflected from the second reflecting surface to the refracting surface, and is then refracted from the refracting surface to exit the lens, and that light entering the lens through the bottom surface and directly incident on the second reflecting surface is reflected from the second reflecting surface to the refracting surface, and is then refracted from the refracting surface to exit the lens.

### CROSS-REFERENCE TO RELATED APPLICATION

This application claims priority of Taiwanese application no. 094100624, filed on Jan. 10, 2005.

### BACKGROUND OF THE INVENTION

1. Field of the Invention

The invention relates to a lens and a light-emitting device, more particularly to a lens and a light-emitting device that includes the lens.

2. Description of the Related Art

Light-emitting diodes (LEDs) currently play a leading role in light-emitting devices, since, in comparison with other conventional light sources, light-emitting diodes have advantages of low work voltage, lower power consumption, ease of assembly, ease of driving, longer service life, small size, impact durability, stable operating, etc.

However, the conventional light-emitting diodes also have disadvantages. In particular, most light emitted from the light-emitting diode travels along the diode axis, while very little emitted light travels toward the lateral sides of the diodes. As such, the illumination range thereof is only limited to a small area. This is why, at present, a flashlight equipped with a high-luminance LED can only be used in toys or decorations. This is also the reason why a light-emitting device having a large number of LEDs does not have a very good illuminating effect.

In U.S. Pat. No. 6,679,621, there is disclosed a lens that comprises a bottom surface, a reflecting surface, a first refracting surface obliquely angled with respect to a central axis of the lens, and a second refracting surface extending as a smooth curve from the bottom surface to the first refracting surface. In use, light entering the lens through the bottom surface and directly incident on the reflecting surface is reflected from the reflecting surface to the first refracting surface and is then refracted by the first refracting surface to exit the lens in a direction substantially perpendicular to the central axis of the lens. On the other hand, light entering the lens through the bottom surface and directly incident on the second refracting surface is refracted by the second refracting surface to exit the lens in a direction substantially perpendicular to the central axis of the lens. The lens may be advantageously employed with LEDs, for example, to provide side-emitting light-emitting devices. A lens cap attachable to a lens is also provided.

Although the aforesaid side-emitting LED with the lens is capable of effectively directing light to a desired direction, the lens has a sawtooth portion that defines the first refracting surface and that is relatively complex such that it is difficult to prepare the same using conventional techniques, such as cast polymerization or injection molding, which results in higher manufacturing costs.

### SUMMARY OF THE INVENTION

Therefore, the main object of the present invention is to provide a lens and a light-emitting device that can overcome the aforesaid drawbacks of the prior art.

According to one aspect of this invention, there is provided a lens that defines a central axis, and that comprises: a bottom surface; a first reflecting surface obliquely angled with respect to the central axis and extending from the bottom surface in a direction away from the central axis; a second reflecting surface obliquely angled with respect to the central axis; and a refracting surface obliquely angled with respect to the central axis and extending from the second reflecting surface in a direction toward the central axis.

Light entering the lens through the bottom surface and directly incident on the first reflecting surface is reflected from the first reflecting surface to the second reflecting surface, is subsequently reflected from the second reflecting surface to the refracting surface, and is subsequently refracted from the refracting surface to exit the lens.

Light entering the lens through the bottom surface and directly incident on the second reflecting surface is reflected from the second reflecting surface to the refracting surface, and is then refracted from the refracting surface to exit the lens.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic partly sectional view of the first preferred embodiment of a light-emitting device according to the present invention;

FIG. 2 is a schematic view of a lens of the light-emitting device of the first preferred embodiment;

FIG. 3 is a schematic view of the second preferred embodiment of a lens of a light-emitting device according to the present invention;

FIG. 4 is a schematic view of the third preferred embodiment of a lens of a light-emitting device according to the present invention;

FIG. 5 is a schematic view of the fourth preferred embodiment of a light-emitting device according to the present invention;

FIG. 6 is a fragmentary perspective view to illustrate how the light-emitting device of this invention is mounted in a light guide;

FIG. 7 is a fragmentary schematic view to illustrate how light passes through the lens of the light-emitting device of this invention and is guided by the light guide of FIG. 6; and

FIG. 8 is a fragmentary schematic view to illustrate how a plurality of the light-emitting devices of this invention are mounted in a light guide.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

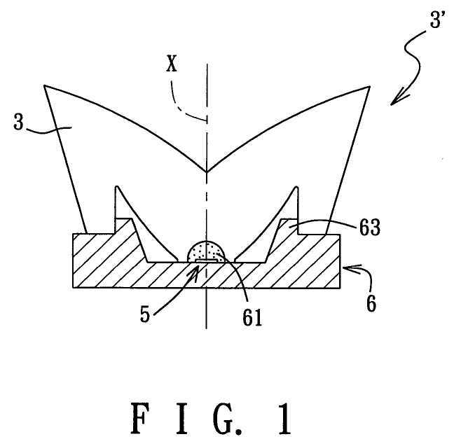

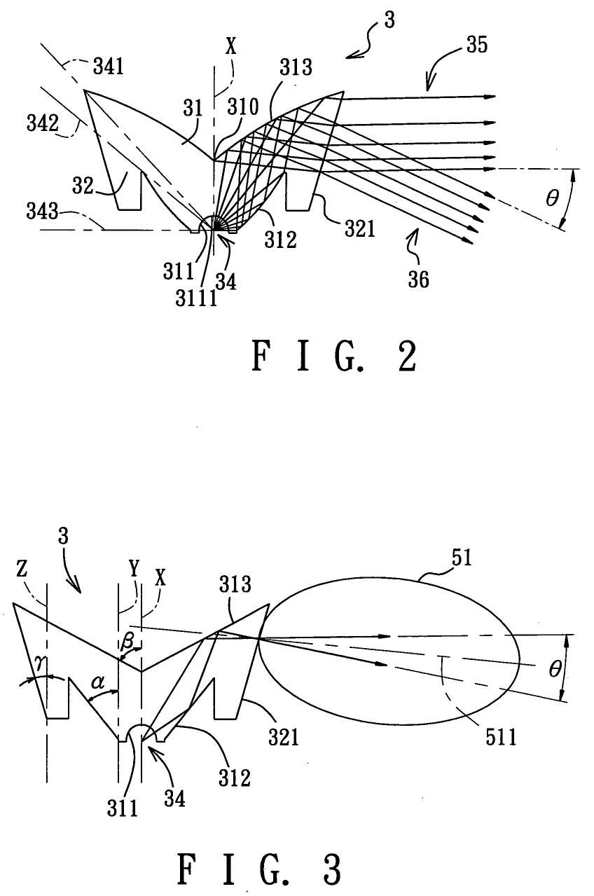

Referring to FIGS. 1 and 2, the first preferred embodiment of a light-emitting device according to the present invention is shown to include a light-emitting unit 3′ that has a package base 6, a light-emitting component 5 and a lens 3, which surround a central axis (X) passing through a geometric center of the aforesaid three components. The package base 6 is one that is currently in wide use in conventional light-emitting diodes, and includes a ring positioning member 63 for positioning the light-emitting component 5, and a sealing body 61 for sealing the light-emitting component 5. The sealing body 61 is a transparent sealant that preferably has a refractive index between 1.4 and 1.7, and is preferably selected from epoxy resin, UV-curable adhesive, and silicone which are currently in wide use in the semiconductor industry. The material used for the sealing body 61 is not limited to the aforesaid three materials, and can be any other suitable adhesive. The light-emitting component 5 is mounted on the package base 6, and includes a light-emitting chip that has a light-emitting pn junction. The lens 3 is mounted on the package base 6, covers the light-emitting component 5, and is coupled to the positioning member 63 by gluing or soldering.

In this embodiment, the lens 3 defines a focal point 34 that lies on the central axis (X). The light-emitting component 5 is located at the focal point 34. The lens 3 includes a funnel-shaped reflecting part 31 that has an upper center point 310 opposite to the focal point 34 and aligned with the focal point 34 along the central axis (X), and a refracting part 32 that extends from an edge of the reflecting part 31 distal from the focal point 34, and that surrounds the reflecting part 31. The reflecting part 31 includes a bottom surface 311 that is disposed proximate to the focal point 34, a first reflecting surface 312 extending from the bottom surface 311 and obliquely angled with respect to the central axis (X), and a second reflecting surface 313 extending from the upper center point 310 of the reflecting part 31, obliquely angled with respect to the central axis (X), and spaced apart from and opposite to the first reflecting surface 312 along the central axis (X). Preferably, the first and second reflecting surfaces 312, 313 have characteristics of total internal reflection.

The refracting part 32 includes a refracting surface 321 extending from an upper edge of the second reflecting surface 313, obliquely angled with respect to the second reflecting surface 313, and disposed distally of the central axis (X). The angle formed between the refracting surface 321 and the central axis (X) is smaller than that formed between the first reflecting surface 312 and the central axis (X).

The bottom surface 311 of the reflecting part 31 has a semi-spherical recess portion 3111 that has a center defining the focal point 34 of the lens 3 so that light-emitting from the light-emitting component 5 enters the bottom surface 311 in a normal direction relative to the semi-spherical recess portion 3111. In this embodiment, the first and second reflecting surfaces 312, 313 are conic in shape, i.e., the cross-section of each of the first and second reflecting surfaces 312, 313 along the central axis (X) is a curve of second order. The refracting surface 321 is a flat surface, i.e., the cross-section of the refracting surface 321 along the central axis (X) is a straight line. However, the shapes of the first and second reflecting surfaces 312, 313 and the refracting surface 321 can be modified in accordance with design requirements.

The lens 3 thus formed permits light, emitting from the light-emitting component 5 at the focal point 34, entering the lens 3 through the bottom surface 311, and directly incident on the first reflecting surface 312, to be reflected from the first reflecting surface 312 to the second reflecting surface 313, to be reflected subsequently from the second reflecting surface 313 to the refracting surface 321, and then to be refracted from the refracting surface 321 to exit the lens 3 to form a first refracted light beam 35.

The lens 3 thus formed also permits light, emitting from the light-emitting component 5 at the focal point 34, entering the lens 3 through the bottom surface 311, and directly incident on the second reflecting surface 313, to be reflected from the second reflecting surface 313 to the refracting surface 321 and then to be refracted from the refracting surface 321 to exit the lens 3 to form a second refracted light beam 36.

In addition, the lens 3 defines a first partition line 341 extending from the focal point 34 to the upper edge of the second reflecting surface 313, a second partition line 342 extending from the focal point 34 to an upper edge of the first reflecting surface 312, and a third partition line 343 extending from the focal point 34 in a horizontal direction perpendicular to the central axis (X). Light-emitting from the focal point 34 and traveling within an angle formed between the central axis (X) and the first partition line 341 forms the first refracted light beam 35. Light-emitting from the focal point 34 and traveling within an angle formed between the second and third partition lines 342, 344 forms the second refracted light beam 36. The first and second refracted light beams 35, 36 form an emitting angle θ therebetween. Light-emitting from the focal point 34 and traveling within an angle formed between the first and second partition lines 341, 342 is directly refracted through the refracting surface 321 in a divergent manner (not shown in the Figure).

FIG. 3 illustrates the second preferred embodiment of this invention, which differs from the previous embodiment in that the first and second reflecting surfaces 312, 313 are flat surfaces. For convenience in illustration, there is defined a first line (Y) parallel to the central axis (X) and passing through a lower edge of the first reflecting surface 312 that is disposed proximate to the focal point 34, and a second line (Z) parallel to the central axis (X) and passing through a lower edge of the refracting surface 321 that is disposed proximate to the focal point 34. The first reflecting surface 312 and the first line (Y) form a first angle α therebetween. The second reflecting surface 313 and the central axis (X) form a second angle β therebetween. The refracting surface 321 and the second line (Z) form a third angle γ therebetween. In this embodiment, the first, second and third angles α, β, γ are acute angles, the second angle β is larger than the first angle α, and the first angle α is larger than the third angle γ. The radiation pattern 51 formed through the lens 3 has a symmetrical axis 511 that defines the directivity of the radiation pattern 51.

It should be noted that the refracting surface 321 can be curved such that light beams are emitted therethrough are in a parallel manner.

The material used for making the lens 3 preferably has a refractive index ranging from 1.4 to 3.5, and is preferably selected from the group consisting of polymethylmethacrolate (PMMA), polycarbonate (PC), silicones, polyetherimide (PEI), CaF₂, silicon, cyclic olefin copolymer (COC), etc. Suitable materials for the lens 3 vary according to the wavelength of the light generated by the light-emitting component 5. For instance, within the visible light range, the material available for selection and with the minimum refractive index is CaF₂, because, when the light wavelength is between 400 and 700 nanometers, the refractive index of CaF₂ is between 1.432 and 1.439. When the light wavelength is within the range of infrared light, material available for selection is silicon, which has a refractive index of 3.497. Nevertheless, in different operating environments, other transparent materials may be better candidates for the lens 3. For instance, for an operating environment that encounters a lot of friction and impact, glass that has better hardness and endurance is more suited for making the lens 3. The sealing body 61 for the light-emitting component 5 preferably has the same refractive index as the lens 3 so that when the bottom surface 311 is not formed with the semi-spherical recess portion 3111, light-emitting from the focal point 34 and entering the bottom surface 311 will not be bent further. The first reflecting surface 312 and the package base 6 are preferably separated by air that has a refractive index of 1 so that light directly incident on the first reflecting surface 312 through the bottom surface 311 will encounter total internal reflection.

The lens 3 thus constructed can be manufactured through existing techniques, such as cast polymerization, injection molding, diamond cutting, etc. Diamond cutting yields the best quality, but takes up more time and is more expensive. On the other hand, cast polymerization and injection molding save cost, and are suited for mass production.

For instance, during injection molding, the lens 3 can be made using an injection mold having first and second portions which are first assembled together for subsequent processing. The material, such as glass, is melted, and is subsequently filled into the mold through injection using a threaded rod. Then, after disposing under a constant pressure and a cooling process, the final product thus formed is removed from the mold. The quality of the product is affected mostly by conditions of the thermal-mechanical process, i.e., the conditions of filling process, working pressure, and cooling process. In sum, the thermal-mechanical process decides the extent of residual stress and deformity of the product. As known to those skilled in the art, the more complicated the design of the mold is, the more difficult the parameter control will be for the thermal-mechanical process.

Since the refracting surface 321 of the lens 3 is flat, the injection mold only needs two symmetric mold halves for making the lenses 3 of FIGS. 2 and 3, and the existing injection machine can be readily used without any modification.

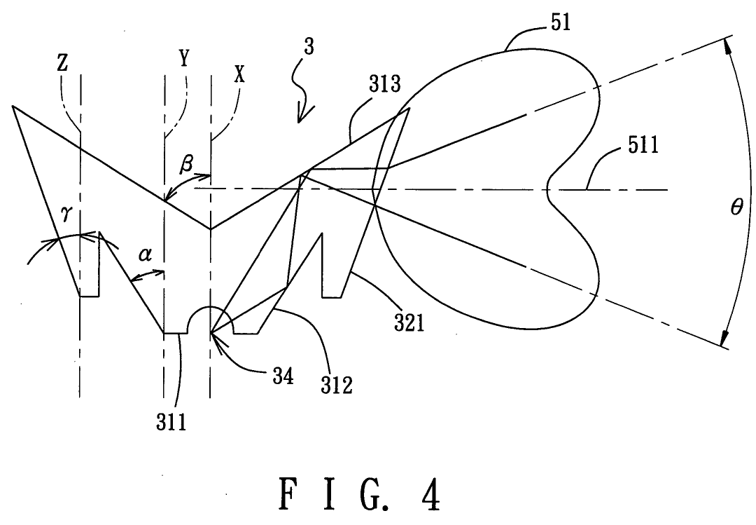

FIG. 4 illustrates the third preferred embodiment of light-emitting device according to this invention. This embodiment differs from the second preferred embodiment in that the first, second, and third angles α, β, γ of the lens 3 of this embodiment are different from those of the second preferred embodiment such that the emitting angle θ is greater than that of the second preferred embodiment and that the directivity of the radiation pattern 51 of the lens 3 of this embodiment has two directions that are symmetric with respect to the axis 511.

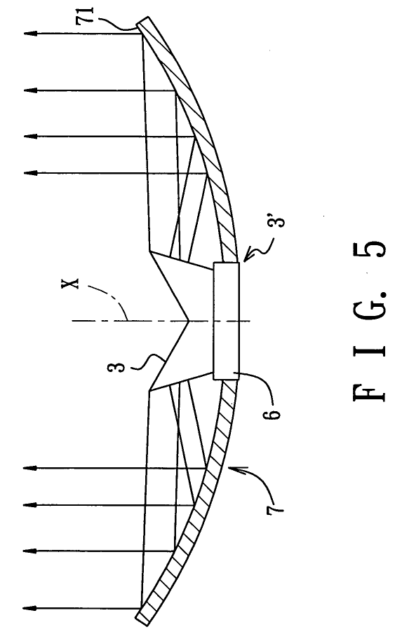

FIG. 5 illustrates the fourth preferred embodiment of a light-emitting device according to the present invention. The light-emitting device differs from the second preferred embodiment in that the light-emitting device further includes a curved reflecting member 7 having a center that lies on the central axis (X). Light beams passing through the lens 3 are incident on a reflecting surface 71 of the reflecting member 7 and are reflected by the reflecting member 7. Since most light beams passing through the lens 3 are focused within a diffusion angle θ, the intensity of the light beams reflected by the reflecting member 7 can be enhanced, and the illumination range can be widened.

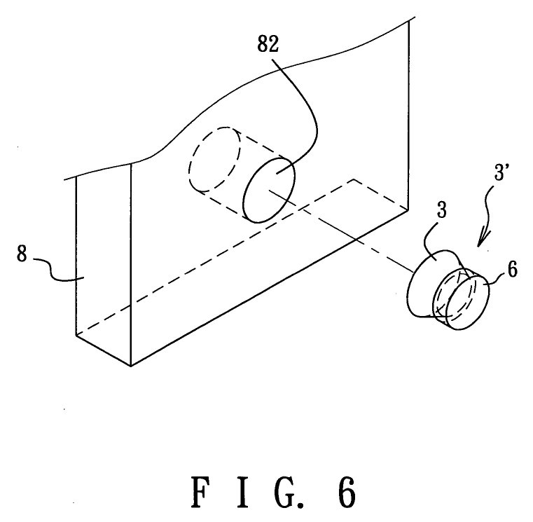

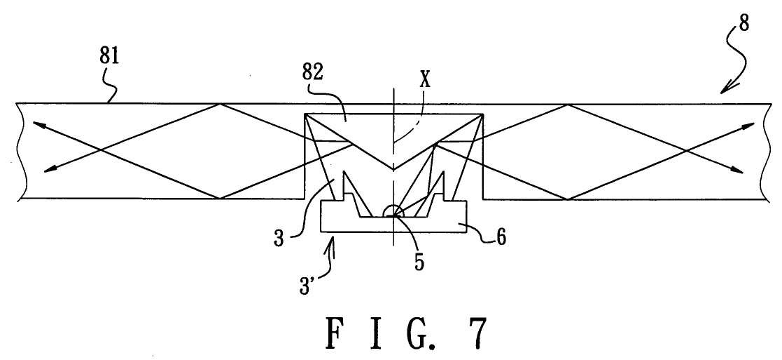

FIGS. 6 and 7 illustrate the fifth preferred embodiment of the light-emitting device according to the present invention. The light-emitting device of this embodiment differs from the second preferred embodiment in that the light-emitting device further includes a light guide 8. The light guide 8 is in the form of an elongated plate, and includes a peripheral wall 81. A blind hole 82 is formed in the peripheral wall 81 for receiving the lens unit 3′ therein. Through repeated total internal reflection by the peripheral wall 81, light emitted from the lens 3 is able to travel along the elongated direction of the light guide 8 so as to obtain a homogenized light that exits the light guide 8. According to the principle of refraction, the condition for generating total internal reflection requires the refractive index of the light guide 8 to be higher than the ambient refractive index, and the incident angle of the light beam incident on the peripheral wall 81 to be larger than a critical angle. Therefore, it is desirable to design a lens that is capable of permitting the light beams, which pass therethrough, to have an incident angle incident on the light guide 8 greater than the critical angle. The total internal reflection can be achieved by adjusting the emitting angle θ (see FIG. 3). For instance, when the light guide 8 has a refractive index of 1.48 and a critical angle of 42.5 degrees, the total internal reflection can be achieved by setting the emitting angle θ of the lens 3 smaller than 90 degrees.

The shape of the light guide 8 can be changed in accordance with design requirements. For instance, an embodiment (not shown) realized in a column shape can be used to provide desired illumination.

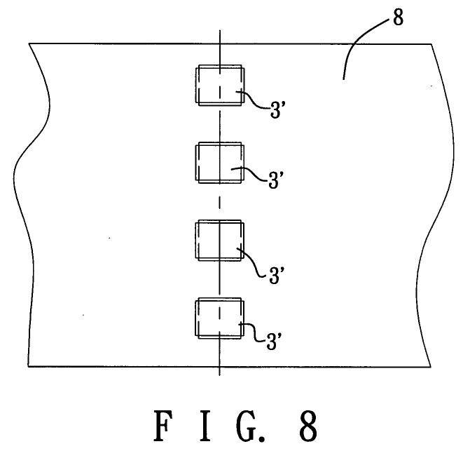

FIG. 8 illustrates the sixth preferred embodiment of the light-emitting device according to the present invention. The light-emitting device of this embodiment differs from the fifth embodiment in that a plurality of the lens units 3′ are mounted in the light guide 8.

From the foregoing, the lens 3 of the light-emitting device of this invention has a simple structure as compared to the prior art, is thus capable of reducing manufacturing costs, and can provide high illumination and wide illumination range.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A lens defining a central axis, said lens comprising:
a bottom surface;
a first reflecting surface obliquely angled with respect to the central axis and extending from said bottom surface in a direction away from the central axis;
a second reflecting surface obliquely angled with respect to the central axis; and
a refracting surface obliquely angled with respect to the central axis and extending from said second reflecting surface in a direction toward the central axis;
wherein light entering said lens through said bottom surface and directly incident on said first reflecting surface is reflected from said first reflecting surface to said second reflecting surface, is subsequently reflected from said second reflecting surface to said refracting surface, and is then refracted from said refracting surface to exit said lens and to form a first refracted light beam; and
wherein light entering said lens through said bottom surface and directly incident on said second reflecting surface is reflected from said second reflecting surface to said refracting surface, and is then refracted from said refracting surface to exit said lens to form a second refracted light beam.

2. The lens as claimed in claim 1, wherein said first and second refracted light beams form an emitting angle therebetween, said emitting angle being greater than 0 degree and less than 90 degree.

3. The lens as claimed in claim 1, wherein said first and second reflecting surfaces being V-shaped, said bottom surface, said first and second reflecting surfaces, and said refracting surface being disposed coaxially around the central axis.

4. The lens as claimed in claim 3, wherein said first reflecting surface forms a first acute angle with a plane normal to the central axis, said second reflecting surface forming a second acute angle with the plane normal to the central axis, said second acute angle being larger than said first acute angle.

5. The lens as claimed in claim 4, wherein said refracting surface forms a third acute angle with the plane normal to the central axis, said third acute angle being less than said first and second acute angles.

6. The lens as claimed in claim 3, wherein said first and second reflecting surfaces are flat surfaces.

7. The lens as claimed in claim 3, wherein said first and second reflecting surfaces are curved.

8. The lens as claimed in claim 7, wherein each of said first and second reflecting surfaces is conic in shape.

9. The lens as claimed in claim 1, wherein the material for forming said lens has a refractive index ranging from 1.4 and 3.5.

10. The lens as claimed in claim 1, wherein the material for forming said lens is selected from the group consisting of PMMA, PC, silicones, PEI, CaF₂, and COC.

11. The lens as claimed in claim 1, wherein said first and second reflecting surfaces reflect the light by total internal reflection.

12. An light-emitting device comprising:
a package base;
a light-emitting member mounted on said package base; and
a lens mounted on said package base, covering said light-emitting member, and defining a central axis, said lens including:
a bottom surface,
a first reflecting surface obliquely angled with respect to the central axis and extending from said bottom surface in a direction away from the central axis,
a second reflecting surface obliquely angled with respect to the central axis, and
a refracting surface obliquely angled with respect to the central axis and extending from said second reflecting surface in a direction toward the central axis;
wherein, light emitted by said light-emitting component, entering said lens through said bottom surface, and directly incident on said first reflecting surface is reflected from said first reflecting surface to said second reflecting surface, is subsequently reflected from said second reflecting surface to said refracting surface, and is then refracted from said refracting surface to exit said lens to form a first refracted light beam; and
wherein light emitted by said light-emitting component, entering said lens through said bottom surface, and directly incident on said second reflecting surface is reflected from said second reflecting surface to said refracting surface, and is then refracted from said refracting surface to exit said lens to form a second refracted light beam.

13. The lens as claimed in claim 12, wherein said first and second refracted light beams form an emitting angle therebetween, said emitting angle being greater than 0 degree and less than 90 degree.

14. The light-emitting device as claimed in claim 12, wherein said first and second reflecting surfaces being V-shaped, said bottom surface, said first and second reflecting surfaces, and said refracting surface being disposed coaxially around the central axis.

15. The light-emitting device as claimed in claim 14, wherein said first reflecting surface forms a first acute angle with a plane normal to the central axis, said second reflecting surface forming a second acute angle with the plane normal to the central axis, said second acute angle being larger than said first acute angle.

16. The light-emitting device as claimed in claim 15, wherein said refracting surface forms a third acute angle with the plane normal to the central axis, said third acute angle being less than said first and second acute angles.

17. The light-emitting device as claimed in claim 14, wherein said first and second reflecting surfaces are flat surfaces.

18. The light-emitting device as claimed in claim 14, wherein said first and second reflecting surfaces are curved.

19. The light-emitting device as claimed in claim 18, wherein each of said first and second reflecting surfaces is conic in shape.

20. The light-emitting device as claimed in claim 12, wherein the material for forming said lens has a refractive index ranging from 1.4 and 3.5.

21. The light-emitting device as claimed in claim 12, wherein the material for forming said lens is selected from the group consisting of PMMA, PC, silicones, PEI, CaF₂, and COC.

22. The light-emitting device as claimed in claim 12, wherein said first and second reflecting surfaces reflect the light by total internal reflection.
